(19) United States
(12) Patent Application Publication
(10) Pub. No.: US 2024/0343473 A1
(43) Pub. Date: Oct. 17, 2024

(54) WALL COMPONENT FOR AN EXPANDABLE INFUSION CONTAINER

(71) Applicant: Swiss Tea Innovation AG, Olten (CH)

(72) Inventors: Joseph Alain SCHERRER, Wangen b. Olten (CH); Franco DEL BON, Aarburg (CH); Theodor WÜST, Wetzikon (CH)

(73) Assignee: Swiss Tea Innovation AG, Olten (CH)

(21) Appl. No.: 18/683,640

(22) PCT Filed: Aug. 15, 2022
(86) PCT No.: PCT/EP2022/072754

§ 371 Date: Feb. 14, 2024

(30) Foreign Application Priority Data
Aug. 16, 2021 (CH) 070169/2021

(51) Int. Cl. B65D 85/816; B29C 45/14; B29L 31/00; B65D 21/08; B65D 77/20

(52) U.S. Cl. CPC B65D 85/816; B29C 45/14008; B65D 21/086; B65D 77/2024; B29L 2031/717

(57) ABSTRACT

The invention relates to a wall part (23) for an expandable infusion container (20) to accommodate a dry infusion substance for preparing an infusion beverage, an infusion container and a method for producing a wall part. The wall part has a first end (231) and a second end (232) and a deformable tubular film (233) connecting the first end (231) and the second end (232). The first end (231) has a fastening ring (50) which is integrally connected to the tubular film (233).

The present invention relates to a wall component for an expandable infusion container, an expandable infusion container and a method for producing a wall part for an expandable infusion container according to the preamble of the independent claims.

In the context of the present invention, an infusion beverage is understood to be any type of beverage which can be prepared, starting from a dry infusion substance, by contact with a cold or hot infusion liquid. A typical infusion beverage is, for example, tea, which is prepared by brewing tea leaves or herbs with hot water.

It is known that t different types of tea require a comparatively long brewing time of a few minutes to develop their aroma. The contact time between the tea leaves and the brewing water must therefore be sufficiently long.

Known from EP 3 119 245 B1 is a tea preparation device and a method which allows a measured amount of a dry infusion substance to be brought in contact with an infusion liquid for a certain contact time. This is made possible by an expandable infusion container. In order to bring the infusion liquid into the container, a lid of this container is pierced with a filling needle and the infusion liquid is introduced into the container through this filling needle. To empty the infusion container, an outlet valve is provided which opens when the pressure inside the infusion container exceeds a certain level. The overpressure is achieved by compressing the container with an extrusion piston.

Depending on the dry infusion substance, the latter can be present in a more or less compressed form. In order to wet the dry infusion substance completely, it must be in a relatively loose form. For this purpose, the infusion container is expandable so that the dry infusion substance can be wetted on all sides. In order to be able to increase, i.e., expand, the volume of the infusion container, a bellows is provided in EP 3 119 245 B1, which takes up little space when folded up and can provide a relatively large volume when pulled apart. The production of a bellows is relatively complex and correspondingly expensive. In addition, due to a large number of different production steps, a correspondingly large number of quality inspections must be carried out so that it can be ensured that the bellows is tight and that the aromas of the dry infusion substance contained therein are preserved.

It is the object of the invention to eliminate at least one or more disadvantages of the prior art. In particular, a wall part for an expandable infusion container is to be created which is simple and, in particular, inexpensive to produce, conserves resources and enables high repeat accuracy during manufacture and, in particular, enables simple expansion.

This object is achieved by the devices and methods defined in the independent patent claims. Further embodiments are apparent from the dependent patent claims.

A wall part according to the invention for an expandable infusion container for accommodating a dry infusion substance for the preparation of an infusion beverage has a first end and a second end. The wall part also has a deformable tubular film connecting the first end and the second end. The first end has a fastening ring which is integrally connected to the tubular film.

A tubular film is an element made of a material with a circumferential, closed wall that has a low wall thickness relative to its length or flat extent. In the present case, the wall thickness is less than 0.2 mm, preferably less than 0.1 mm, but at least 0.01 mm thick. The tubular film is preferably exactly 0.1 mm thick.

In the present case, the tubular film can be a film made of PET, PEF or a comparable material. It is preferably heat-resistant for temperatures up to 100° C., preferably for temperatures up to 150° C., in particular for temperatures up to 200° C. The tubular film is in particular plasticizer-free, tear-resistant and has a high resistance to creasing.

A tubular film can be produced, for example, as a single or multi-layer blown film, alternatively it can also be wound and welded.

By forming a fastening ring at the first end of the tubular film, it can be easily connected to a corresponding base part of an infusion container, for example.

This is simplified in particular by the fact that the tubular film is integrally connected to the fastening ring. The tubular film therefore does not have to be laboriously clamped to the base part; only the fastening ring has to be connected to a corresponding counterpart on the base part.

It can be provided that the second end of the wall part is designed as the lid part of the infusion container. In this case, the lid part is integrally connected to the tubular film.

By forming the second end as a lid part of the infusion container, in particular by the integral connection of the tubular film to the lid part, an additional work step for connecting the tubular film to the lid part can be omitted.

The integral connection between the lid part and the tubular film also makes it possible to simplify the production process. In particular, additional quality inspections can be dispensed with since a separate and/or later connection between the tubular film and the lid part does not need to be checked.

This applies equally to the connection between the tubular film and the fastening ring.

The first end and the second end can be connected to each other via a helical structure.

On the one hand, a helical structure increases the stability of the wall part, and on the other hand, the helical structure can provide an elastic element in the form of a coil spring. This elastic element supports the unfolding process when the expandable infusion container expands.

The helical structure can be integrally connected to the tubular film. The tubular film is thus supported and guided. The tubular film is therefore connected to the coil of the helical structure and moves together with the coil of the helical structure. If the infusion container is pressed from its expanded form into its collapsed form, the tubular film is guided by the helical structure and retains its diameter in the region of its connection to the helical structure, or the diameter becomes slightly larger.

When the infusion container is compressed, it can also be slightly twisted or torqued so that the outer diameter of the tubular film and thus also the outer diameter of the helical structure remains constant.

The connection between the tubular film and the lid part and/or the fastening ring and/or the helical structure can be formed as an injection-molded connection.

By forming an injection-molded connection, an integral connection between two elements can be implemented in a relatively simple manner. For example, the tubular film can be overmolded and thus enclosed from two sides; overmolding or injecting elements onto a film also allows a connection by partial melting or fusing, so that the surfaces are at least partially interlocked.

Preferably, the lid part and the fastening ring and the helical structure are formed in one piece.

As a result, further or additional interfaces between the individual elements can be avoided, which in turn has a positive influence on the susceptibility to errors.

One-piece production is particularly advantageous in the injection molding process.

All elements manufactured together can be formed uniformly and homogeneously.

The lid part of the wall part can have one or more openings. A sealing film can be arranged on the lid part to close these openings.

As a result of the openings on the lid part, both material and weight can be saved.

Another aspect of the invention relates to an expandable infusion container for accommodating a dry infusion substance for the preparation of an infusion beverage. The infusion container comprises a base part, a lid part and a wall part connecting the base part and the lid part. The wall part is designed in particular as described in the present case. The wall part has a variable length. A first end of the wall part has an integral fastening ring. The wall part is fastened to the base part of the infusion container by means of this fastening ring.

The integral fastening ring makes it easy to fasten the wall part to the base part. Accordingly, the infusion container can be produced in a simple and inexpensive manner.

It can be provided that the lid part is designed as an integral part of the wall part.

The design of the lid part as an integral part of the wall part makes it possible to dispense with a further step in the manufacturing process. A separate step for connecting the lid part to the wall part can be omitted. This increases process reliability and simplifies quality control.

The fastening ring and the lid part can be connected to each other via a helical structure.

The lid part is thus held securely on the fastening ring.

A tubular film can extend between the fastening ring and the lid part.

The tubular film can be used to create a space or volume between the lid part and the fastening ring into which, for example, the dry infusion substance can be introduced. The tubular film allows for the wall part to be designed in an airtight manner so that aromas from the dry infusion substance cannot evaporate.

The tubular film and the fastening ring and/or the lid part and/or the helical structure can have an integral connection.

An integral connection is reliable and safe and meets high quality standards that can be achieved with simple means. Forming an integral connection also makes it possible to dispense with complex quality control tests. It is also possible to eliminate additional connecting steps.

The connection between the tubular film and the lid part and/or the fastening ring and/or the helical structure can be formed as an injection-molded connection.

By forming an injection-molded connection, an integral connection between two elements can be implemented in a relatively simple manner. For example, the tubular film can be overmolded and thus enclosed from two sides; overmolding or injecting molding elements onto a film also allows a connection by partial melting or fusing, so that the surfaces are at least partially interlocked.

This also allows the lid part to be manufactured in one piece together with the fastening ring and the helical structure, the advantages of which have already been described in relation to the wall part and apply equally.

An inlet valve can be arranged on the lid part. By providing an inlet valve it can be ensured that the lid part can be closed in a reliable and tight manner.

An outlet valve can be arranged on the base part. By providing an outlet valve, it can be ensured that the base part can be closed in a reliable and tight manner.

In its collapsed form, the infusion container can thus be closed in an airtight manner.

Valves also enable specific opening and closing of the infusion container.

In addition, it can be provided that a filter screen is arranged on the base part. In particular, the filter screen is arranged such that a fluid flow from the interior of the infusion container is filtered in the direction towards the outlet valve.

A further aspect relates to a method for producing a wall part for an expandable infusion container for accommodating a dry infusion substance for preparing an infusion beverage, in particular a wall part as described hereinbefore. The wall part is in particular provided for an expandable infusion container as described in the present case. The method comprises the following steps:
providing a tubular film,
positioning the tubular film on a mold core,
inserting the mold core into an injection mold,
injection molding a fastening ring directly onto the tubular film so that the tubular film so that the fastening ring and the tubular film are integrally connected,
demolding the tubular film with the injection-molded fastening ring.

This allows the simple and cost-effective manufacture of a wall part that has a tubular film and a fastening ring as integral components. The connection between the fastening ring and the tubular film is created directly by injection molding, and an additional step to connect these two elements is not necessary.

During the injection molding of the fastening ring, a lid part can be injection molded directly onto the tubular film in the same step so that the lid part and the tubular film are also integrally connected.

This manufacturing step simplifies the manufacture of the wall part and makes it possible to dispense with a further step for connecting the tubular film to the lid part. The lid part no longer needs to be produced separately and a subsequent interface between the lid part and the tubular film is no longer required, just as an interface between the tubular film and the fastening ring is no longer required.

During the injection molding of the fastening ring, a helical structure can be injected directly onto the tubular film in the same step, so that the helical structure and the tubular film are integrally connected.

This step also simplifies manufacture and makes it possible to dispense with additional steps for attaching the tubular film to the helical structure.

Injecting or overmolding a film also allows for a connection by partial melting or fusing, so that the surfaces of the film and the molded or overmolded element are at least partially interlocked.

The tubular film is a deformable tubular film.

The use of a deformable tubular film ensures that the wall part can be collapsed after production.

It can be provided that the lid part is moved towards the fastening ring. As a result, the helical structure becomes slightly larger in diameter. Alternatively, it can also be provided that during the movement of the lid part towards the fastening ring, the wall part is slightly torqued so that the outer diameter of the helical structure does not change.

Various aspects of the invention are explained below with reference to schematic figures. In the figures:

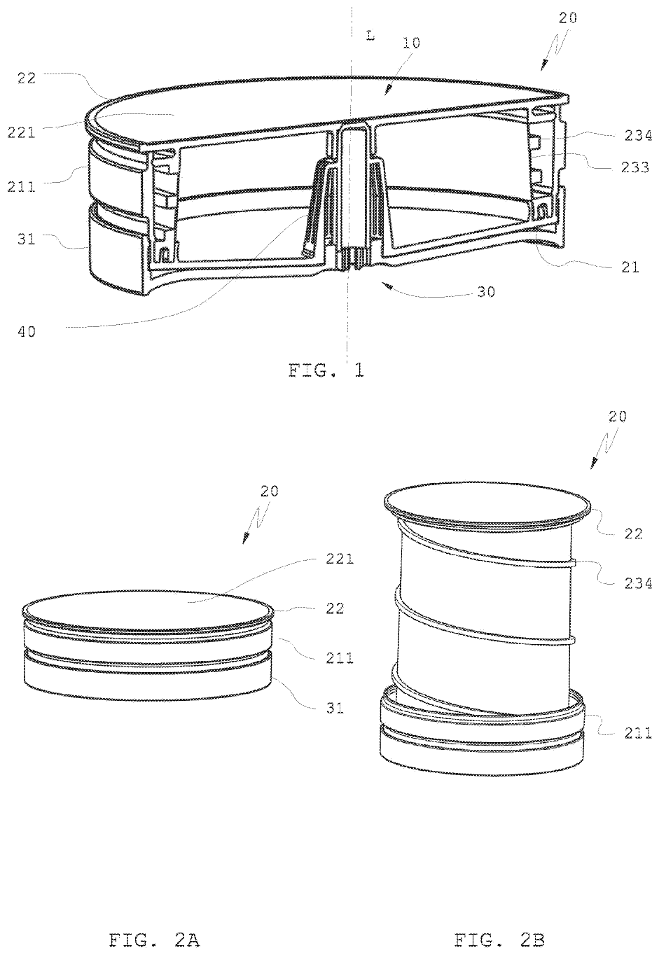

FIG. 1: shows a perspective sectional view of infusion container;

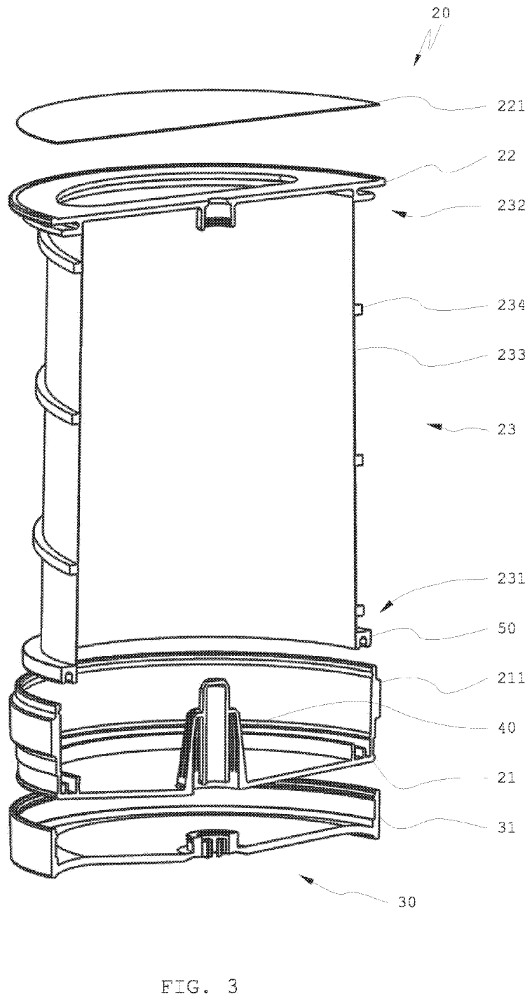

FIG. 2A: shows a perspective view of the infusion container of FIG. 1 in a collapsed form;

FIG. 2B: shows a perspective view of the infusion container of FIG. 2A in an expanded form;

FIG. 3: shows an exploded view of the infusion container of FIG. 1;

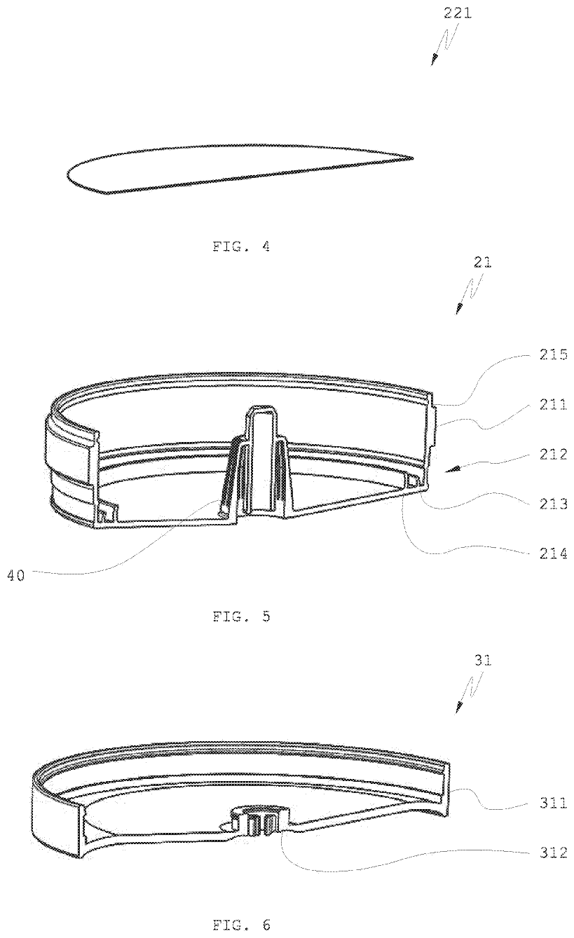

FIG. 4: shows a perspective view of a sealing film;

FIG. 5: shows a perspective view of a base part;

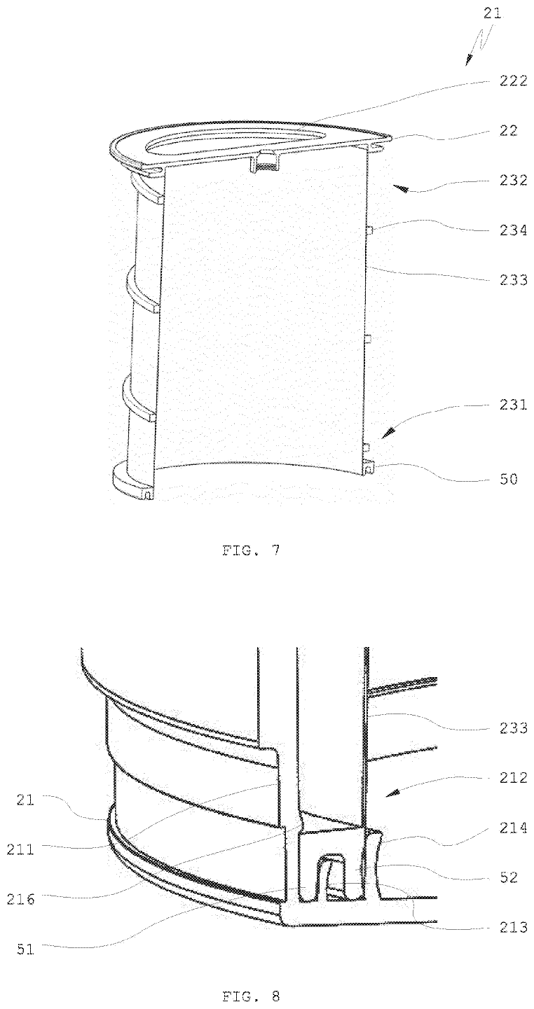

FIG. 6: shows a perspective view of a closure;

FIG. 7: shows a perspective view of a wall part;

FIG. 8: shows a detailed view from FIG. 1;

FIG. 9: shows a perspective view of a mold core;

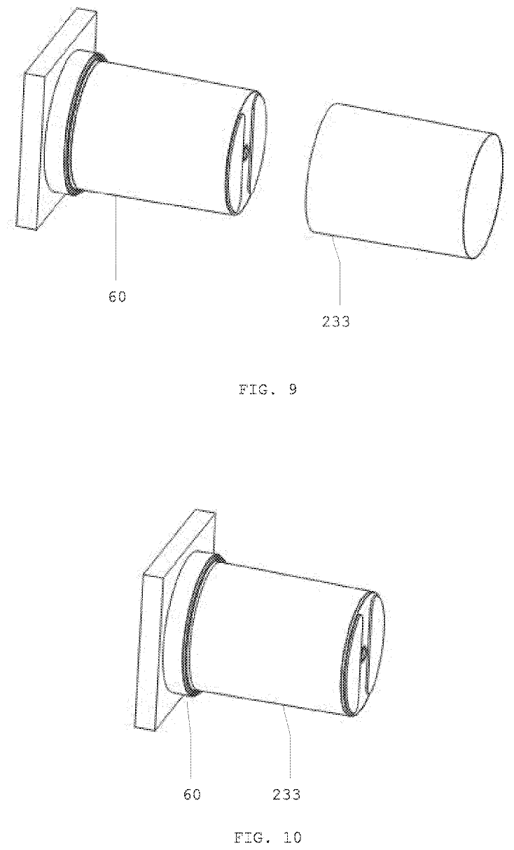

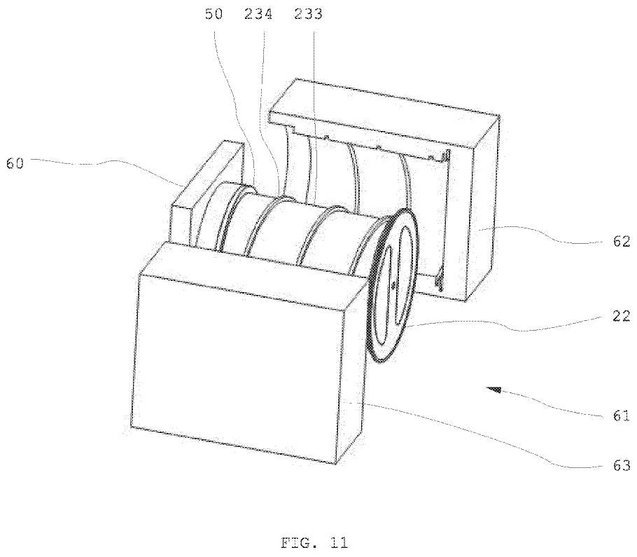

FIG. 10: shows a perspective view of the mold core according to FIG. 9 with a tubular film arranged thereon;

FIG. 11: shows a perspective view of the mold core and the mold halves.

For the sake of clarity, the illustration of any dry infusion substance in the infusion container 20 is omitted in all of the figures.

FIG. 1 shows a perspective sectional view of an infusion container 20. The infusion container 20 has an inlet valve 10 and an outlet valve 30 with a dispensing opening. The infusion container itself comprises a base part 21, a lid part 22 and a wall part 23. The wall part 23 is expandable and, in the present case, comprises a tubular film 233. The wall part 23 is connected on one side to the base part 21 in a liquid-tight manner and on the other side to the lid part 22 in a liquid-tight manner. A helical structure 234 is formed circumferentially around the tubular film 232. This wall part 23 is enclosed by the base part 21 and the lid part 22. For this purpose, a hollow cylindrical wall 211 extending in the direction of the lid part 22 is provided on the base part 21 at the periphery thereof.

It can also be seen that the outlet valve 30 is at least partially formed as an integral component of the base part 21. A closure 31 is provided to complete the outlet valve 30. A filter screen 40, which is arranged upstream of the outlet opening and thus of the outlet valve 30, is also illustrated.

As can be seen in FIG. 1, the inlet valve 10 is at least partially formed as a component of the lid part 22 and cooperates with a corresponding counterpart of the base part 21. This counterpart is an extension of the filter screen 40. A sealing film 221 is arranged on the lid part 22 and closes the inlet valve 10.

The infusion container 20 according to FIG. 1 is formed to be substantially rotationally symmetrical and has a central axis L. The latter also defines an axial direction. A central axis is also present in non-rotationally symmetrical designs of the infusion container 20. This central axis is substantially defined by the connection between the inlet valve 10 and outlet valve 30. The inlet valve 10 and the outlet valve 30 also define a flow direction which runs from the inlet valve 10 to the outlet valve 30.

FIG. 2A shows a perspective view of the infusion container from FIG. 1 in the collapsed form. It can be seen that the infusion container 20 in this form substantially consists of the base part 21 (see FIG. 1), which is arranged inside the closure 31, the hollow cylindrical wall 211 and the lid part 22, which is closed with the sealing film 221, and that the expandable wall part located inside the infusion container 20 is arranged such that it is protected by these elements.

As can be seen from FIG. 2A and from FIG. 1, in the collapsed form, the base part 21 is connected to the lid part 22 via the wall 211 arranged at the periphery of the base part.

FIG. 2B shows a perspective view of the infusion container 20 of FIG. 2A in an expanded form. By introducing an overpressure via the inlet valve 10 (see FIG. 1), the lid part 22 has been pushed out of a corresponding seat 215 (see FIG. 5) in the wall 211, and the wall part 23 has been expanded by filling infusion liquid into the infusion container 20. This expansion is supported by the helical structure 234. It is understood that the inlet valve 10 was opened before the overpressure was introduced. Thereafter, the infusion container 20 remains in this expanded form for a predetermined time and is subsequently compressed to dispense the infusion beverage. It is understood that the outlet valve 30 (see FIG. 1) is opened, in particular before compression, and the infusion beverage is dispensed through this outlet valve 30.

FIG. 3 shows an exploded view of the infusion container 20 of FIG. 1. The infusion container 20 has a lid part 22 with a sealing film 221 attached thereto. In the present case, the sealing film 221 is attached to the lid part 22 using an adhesive. However, it is also conceivable that the sealing film 221 is arranged on the lid part 22 by means of ultrasonic welding or by conventional melting/fusing. It can be seen here that the lid part 22 has openings 222, which are also closed with the sealing film 221.

Also illustrated is the wall part 23 which has a first end 231 and a second end 232. The first end 231 and the second end 232 are connected to each other by means of a tubular film 233. In other words, the tubular film 233 has a first end 231 and a second end 232. The first end 231 is integrally connected to the lid part 22. The second end 232 is integrally connected to a fastening ring 50.

A helical structure 234 is formed circumferentially around the tubular film 233, which is also integrally connected to the tubular film 233. The lid part 22, the helical structure 234 and the fastening ring 50 are produced in one piece using an injection molding process and are correspondingly formed as an injection mold. By producing using the injection molding process, these elements can be molded or injected directly onto or at the tubular film 233.

Also illustrated in FIG. 3 is the base part 21 with the wall 211 extending in the direction of the lid part 22. A closure 31 of the outlet valve 30 is arranged on the base part 21. The closure 31 is arranged on the base part 21 in axially displaceable manner.

The closure 31 completely spans the base part 21. A closure body 312 (see FIG. 5) is formed as a central and integral component of the base part 21 which closes an opening on the base part 21. A filter screen 213, which is arranged upstream of a dispensing opening 212, is also illustrated. Moving the closure 31 in an axial direction allows the opening in the base part 21 to be uncovered, thereby opening the outlet valve 30.

In the following figures, individual elements of the infusion container 20 according to FIG. 3 are described in detail.

FIG. 4 shows a perspective view of a sealing film 221. The sealing film is made of polypropylene and has a thickness of between 0.05 mm and 0.1 mm and is 0.8 mm thick here.

FIG. 5 shows a perspective view of a base part 21. A hollow cylindrical wall 211 is arranged on the base part 21. The hollow cylindrical wall 211 has a seat 215 at its upper end for engagement of a lid part 22 (see FIG. 1). For this purpose, a projecting element is formed on the lid part 22. A clamping element 212 is located at the transition between the hollow cylindrical wall 211 and a substantially flat extending base element of the base part 21. The clamping element 212 is formed by a projection 214 axially extending in a substantially planar manner and a part of the hollow cylindrical wall 211. A corresponding counterpart, in the present case a fastening ring 50 (see FIG. 1), can be inserted between these two elements. A substantially axially extending sealing lip 213 is arranged inside the clamping element 212. Both the sealing lip 213 and the projection 214 are formed circumferentially around a center of the base part 21.

A filter screen 40 is arranged centrally on the base part 21.

FIG. 6 shows a perspective view of a closure 31. The closure 31 has a peripheral edge 311 and a centrally arranged closure body 312. A radially inwardly directed extension is formed on the peripheral edge 311, for engagement with a corresponding counterpart on the base part 21.

FIG. 7 shows a perspective view of a wall part 23. The wall part 20 has a first end 231 and a second end 231. In the present case, it comprises a lid part 22, which is arranged at the second end, and a fastening ring 50, which is arranged at the first end 231. The wall part 23 also comprises a helical structure 234. The lid part 22, the helical structure 234 and the fastening ring 50 are manufactured together in one piece using the injection molding process. The wall part 23 also comprises a tubular film 233. The lid part 22, the helical structure 234 and the fastening ring 50 are overmolded or injection-molded onto this tubular film 233. Accordingly, the tubular film 233 has an integral attachment to the lid part 22, the helical structure 234 and the fastening ring 50. These elements are therefore connected to each other in a liquid-tight and airtight manner. An opening 222 is visible in the lid part 22 as well as a portion of the inlet valve 10 (see FIG. 1).

The tubular film is made of PET and has a thickness of 0.1 mm. It is plasticizer-free and heat-resistant up to 200° C.

FIG. 8 shows a detailed view from FIG. 1. It shows a tubular film 233 with an integrally arranged fastening ring 50 having a first leg 51 and a second leg 52. The first leg 51 is spaced from the second leg 52 by a circumferential groove.

The fastening ring 50 is held in the clamping element 212 of the base part 21. The fastening ring 50 is clamped between the hollow cylindrical wall 211 and a circumferential projection 214. In order to prevent axial displacement, a projection 216 is provided on the wall 211, which secures the fastening ring 50 against axial displacement. The sealing lip 213 is in contact with the first leg 51 of the fastening ring 50.

The fastening ring 50 and thus the tubular film 233 integrally fastened thereto is thus held on the base part 21 in a secure and liquid-tight manner.

The following figures show individual steps of a manufacturing method for a wall part 23 as shown in FIG. 7.

FIG. 9 shows a perspective view of a mold core 60 and a tubular film 233. The tubular film 233 is produced by rolling up and welding a single sheet of the film. In the present case, this film is made of PET and has a thickness of 0.1 mm. The tubular film 233 has a first end 231 and a second end 232. The first end 231 has a slightly larger diameter than the second end 232. The tubular film 233 as a whole is therefore formed in conically tapering manner. Accordingly, the mold core 60 is formed conical. In a first step, the tubular film 233 is arranged in front of the mold core 60.

FIG. 10 shows a perspective view of the mold core 60 according to FIG. 9 with the tubular film 233 arranged thereon. The tubular film 233 is positioned on the mold 60. Subsequently, the mold 60 is inserted together with the tubular film 233 into an injection mold 61 (see FIG. 10), or an injection mold 61 is closed around the mold core 60.

Subsequently, appropriately liquefied plastic, in the present case polypropylene, PP, is injected into the injection mold 61, and the fastening ring 50, the helical structure 234 and the lid part 22 are injected onto the tubular film 233.

FIG. 11 shows a perspective view of the mold core 60 and the mold halves 62 and 63 of the injection mold 61. FIG. 11 shows the state after injection molding and after opening the mold halves 62 and 63. As can be seen, the helical structure 234, the lid part 22 and the fastening ring 50 are formed in one piece by injection molding and integrally connected to the tubular film 233 using the injection molding process.

Following the opening of the injection mold 61, the finished wall part can thus be removed from the mold 60.

1. A wall part (23) for an expandable infusion container (20) for accommodating a dry infusion substance for the preparation of an infusion beverage, the wall part (23) comprising:
a first end (231) and a second end (232) and a deformable tubular film (233) connecting the first end (231) and the second end (232), wherein the first end (231) has a fastening ring (50) which is integrally connected to the tubular film (233).

2. The wall part (23) according to claim 1, wherein the second end (232) is formed as a lid part (22) of the infusion container (20), wherein the lid part (22) is integrally connected to the tubular film (233).

3. The wall part (23) according to claim 1, wherein the first end (231) and the second end (232) are connected to each other via a helical structure (234).

4. The wall part (23) according to claim 3, wherein the helical structure (234) is integrally connected to the tubular film (233).

5. The wall part (23) according to claim 1, wherein the connection between the tubular film (233) and the lid part (22) and/or the fastening ring (50) and/or the helical structure (234) is formed as an injection-molded connection.

6. The wall part (23) according to claim 5, wherein the lid part (22) and the fastening ring (50) and the helical structure (234) are formed in one piece.

7. The wall part (23) according to claim 2, wherein the lid part (22) has one or more openings (222), wherein for closing these openings (222), a sealing film (221) is arranged on the lid part (22).

8. An expandable infusion container (20) for accommodating a dry infusion substance for the preparation of an infusion beverage, comprising a wall part (23) according to claim 1, a base part (21), a lid part (22), and the wall part (23) connecting the base part (21) and the lid part (22), wherein the wall part (23) has a variable length, wherein a first end (231) of the wall part (23) has an integral fastening ring (50), and the wall part (23) is fastened to the base part (21) with this fastening ring (50).

9. The expandable infusion container (20) according to claim 8, wherein the lid part (22) is formed as an integral component of the wall part (23).

10. The expandable infusion container (20) according to claim 9, wherein the fastening ring (50) and the lid part (22) are connected to each other via a helical structure (234).

11. The expandable infusion container (20) according to claim 9, wherein a tubular film (233) extends between the fastening ring (50) and the lid part (22).

12. The expandable infusion container (20) according to claim 11, wherein the tubular film (233) and the fastening ring and/or the lid part (22) and/or the helical structure (234) have an integral connection.

13. The expandable infusion container (20) according to claim 12, wherein the connection between the tubular film (233) and the lid part (22) and/or the fastening ring (50) and/or the helical structure (234) is formed as an injection-molded connection.

14. The expandable infusion container (20) according to claim 9, wherein an inlet valve (10) is arranged on the lid part (22).

15. The expandable infusion container (20) according to claim 8, wherein an outlet valve (30) is arranged on the base part (21).

16. The expandable infusion container (20) according to claim 8, wherein a filter screen (40) is arranged on the base part (21).

17. A method for producing a wall part (23), in particular a wall part (23) according to claim 1, for an expandable infusion container (20), for accommodating a dry infusion substance for the preparation of an infusion beverage, the method comprising the steps of:
providing a tubular film (233),
positioning the tubular film on a mold core (60),
inserting the tool core (60) into an injection mold (61),
injection molding a fastening ring (50) directly onto the tubular film (233) so that the fastening ring (50) and the tubular film (233) are integrally connected,
demolding the tubular film (233) with the injection-molded fastening ring (50).

18. The method according to claim 17, wherein during the injection molding of the fastening ring (50), a lid part (22) is injected directly onto the tubular film (233) so that the lid part (22) and the tubular film (233) are integrally connected.

19. The method according to claim 17, wherein during the injection molding of the fastening ring (50), a helical structure (234) is injected directly onto the tubular film (233) so that the helical structure (234) and the tubular film (233) are integrally connected.

20. The method according to claim 17, wherein the tubular film (233) is a deformable tubular film (233).
